(19) United States
(12) Patent Application Publication
(10) Pub. No.: US 2024/0392719 A1
(43) Pub. Date: Nov. 28, 2024

(54) DIESEL EXHAUST AFTERTREATMENT SYSTEMS AND METHODS

(71) Applicant: Roadwarrior Inc., Innisfil (CA)

(72) Inventors: John MUTER, King City (CA); Dawei WANG, Scarborough (CA); Zhengtong LI, Thornhill (CA)

(73) Assignee: Roadwarrior Inc., Innisfil, ON (CA)

(21) Appl. No.: 18/673,976

(22) Filed: May 24, 2024

Related U.S. Application Data
(60) Provisional application No. 63/504,351, filed on May 25, 2023.

(51) Int. Cl. F01N 13/18; B01D 53/94; F01N 3/035; F01N 3/10; F01N 3/20; F01N 13/00

(52) U.S. Cl. CPC F01N 13/1805; B01D 53/9418; B01D 53/9436; B01D 53/944; B01D 53/9477; F01N 3/035; F01N 3/106; F01N 3/2066; F01N 13/009; B01D 2255/1021; B01D 2257/404; B01D 2257/406; B01D 2257/502; B01D 2257/702; B01D 2258/012

(57) ABSTRACT

An exhaust aftertreatment system for a vehicle includes first and second longitudinal frame rails and may include a first housing including a first inlet configured to be fluidly coupled to a supply of a gas, a plurality of diesel oxidation catalysts fluidly coupled to the first inlet, a plurality of diesel particulate filters fluidly coupled to the plurality of diesel oxidation catalysts, and a mixing chamber fluidly coupled to the plurality of diesel particulate filters. The exhaust aftertreatment system may include second housing including an inner channel fluidly coupled to the mixing chamber of the first housing, a selective catalytic reduction catalyst fluidly coupled to the inner channel, and an outlet fluidly coupled to the selective catalytic reduction catalyst and configured to permit the gas to exit the system, wherein the first housing is fluidly coupled to the second housing by a connecting portion.

### CROSS-REFERENCE TO RELATED PATENT APPLICATIONS

This application claims the benefit of and priority to U.S. Provisional Application No. 63/504,351, filed May 25, 2023, the content of which is hereby incorporated by reference in its entirety and for all purposes.

### BACKGROUND

The present disclosure relates generally to the treatment of vehicle exhaust.

Diesel exhaust contains a mixture of gas and fine particles which can negatively impact air quality, including nitrogen oxides (NOx), carbon dioxide (CO₂) and particulate matter (PM). Aftertreatment systems can be installed to mitigate the negative effects of these contaminants. Common aftertreatment systems include one or more of a diesel oxidation catalyst to reduce carbon monoxide (CO), hydrocarbons (HC) and PM; a diesel particulate filter (DPF) to reduce PM; and a selective catalytic reduction catalyst (SCRs) to reduce the level of NOx through reduction reactions converting the NOx into nitrogen, water, and CO₂.

### SUMMARY

An improved diesel exhaust aftertreatment system and method of use is described herein.

In one embodiment, an exhaust aftertreatment system for a vehicle comprising first and second longitudinal frame rails may comprise a first housing comprising: a first inlet configured to be fluidly coupled to a supply of a gas; a plurality of diesel oxidation catalysts fluidly coupled to the first inlet; a plurality of diesel particulate filters fluidly coupled to the plurality of diesel oxidation catalysts; and a mixing chamber fluidly coupled to the plurality of diesel particulate filters; and a second housing comprising: an inner channel fluidly coupled to the mixing chamber of the first housing; a selective catalytic reduction catalyst fluidly coupled to the inner channel; and an outlet fluidly coupled to the selective catalytic reduction catalyst and configured to permit the gas to exit the system, wherein the first housing is fluidly coupled to the second housing by a connecting portion.

In another embodiment, an exhaust aftertreatment system for a vehicle comprising first and second longitudinal frame rails may comprise an inlet configured to be fluidly coupled to a supply of an exhaust gas; a plurality of diesel oxidation catalysts fluidly coupled to the inlet; a plurality of diesel particulate filters fluidly coupled to the plurality of diesel oxidation catalysts; a mixing chamber fluidly coupled to the plurality of diesel particulate filters; a selective catalytic reduction catalyst fluidly coupled to the mixing chamber; and an outlet fluidly coupled to the selective catalytic reduction catalyst and configured to permit the exhaust gas to exit the system, wherein the exhaust gas passes through the plurality of diesel oxidation catalysts and the plurality of diesel particulate filters in a first direction, through the mixing chamber in a second direction substantially opposite to the first direction, and through the selective catalytic reduction catalyst in a third direction substantially perpendicular to the first direction and the second direction.

### BRIEF DESCRIPTION OF THE FIGURES

The disclosure will become more fully understood from the following detailed description, taken in conjunction with the accompanying figures, wherein like reference numerals refer to like elements, in which:

FIGS. 1A and 1B are front perspective views of an exhaust aftertreatment system, according to an embodiment.

FIG. 2 is a rear perspective view of the exhaust aftertreatment system of FIGS. 1A and 1B, according to an embodiment.

FIG. 3 is an exploded view illustrating the first emission control module, the second emission control module, and the connecting cover of the exhaust aftertreatment system of FIGS. 1A and 1B, according to an embodiment.

FIG. 4 is a perspective view of the first emission control module of the exhaust aftertreatment system of FIGS. 1A and 1B, according to an embodiment.

FIG. 5 is perspective view of the second emission control module of the exhaust aftertreatment system of FIGS. 1A and 1B, according to an embodiment.

FIG. 6 is a rear perspective view of an interior of the second emission control module of FIG. 5, according to an embodiment.

FIG. 7 is a rear perspective view of an interior of the second emission control module of FIG. 5, according to an embodiment.

FIG. 8 is a front perspective view of an interior of the second emission control module of FIG. 5, according to an embodiment.

FIG. 9 is a perspective view of a combined SCR/ACR module of the second emission control module of FIG. 5, according to an embodiment.

FIG. 10 is a perspective view of individual SCR/ACR elements in the combined SCR/ACR module of FIG. 9, according to an embodiment.

FIG. 11 is a rear perspective view of an interior of the exhaust aftertreatment system of FIGS. 1A and 1B, according to an embodiment.

FIG. 12 is a rear view of an interior of the exhaust aftertreatment system of FIGS. 1A and 1B, according to an embodiment.

FIG. 13 is a cross-section view of the exhaust aftertreatment system of FIGS. 1A and 1B, according to an embodiment.

FIG. 14 is a rear perspective view of the exhaust aftertreatment system of FIGS. 1A and 1B with mounting hardware, according to an embodiment.

FIG. 15 is a right side perspective view of the exhaust aftertreatment system of FIGS. 1A and 1B illustrating example gas flow paths, according to an embodiment.

FIG. 16 is a left side perspective view of the exhaust aftertreatment system of FIGS. 1A and 1B illustrating example gas flow paths, according to an embodiment.

FIG. 17 is a front perspective view of the exhaust aftertreatment system of FIGS. 1A and 1B illustrating example gas flow paths, according to an embodiment.

FIG. 18 is a perspective view of the second emission control module of the exhaust aftertreatment system of FIGS. 1A and 1B illustrating example gas flow paths, according to an embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting. For example, the exemplary embodiments below are discussed in reference to the treatment of exhaust gas from a diesel engine, however the exemplary embodiments are not limited by and should not be construed to be limited to the treatment of exhaust gas from a diesel engine and can be applied to the treatment of other gas mixtures.

Referring generally to the figures, an aftertreatment system (i.e., a one-box) includes a series of treatment systems designed to treat a gas (i.e., diesel exhaust), arranged in a first emission control module, a second emission control module, and a connecting cover coupled together. The treatment systems include one or more diesel oxidation catalysts (DOCs), one or more diesel particulate filters (DPFs), one or more diesel exhaust fluid (DEF) injectors, one or more mixing chambers (i.e., decomposition chambers), and one or more selective catalytic reduction catalysts (SCRs). The DOCS, DPFs, DEF injectors and mixing chamber can be included in the first emission control module. The SCRs can be included in the second emission control module, which is coupled to the first emission control module by the connecting cover. The orientation of the various elements in the first emission control module directs the gas in a first direction through the DOCs and DPFs, in a second direction opposite the first direction in the mixing chamber, and in a third direction perpendicular to the first and second directions in the SCRs. The arrangement of the modules and the various components provides a compact and efficient exhaust aftertreatment system for mounting on a frame rail of a vehicle. While certain treatment systems and components are referred to herein as positioned within a first housing, a second housing, or the connecting portion, it should be understood that in other embodiments the components can be arranged in different housings or portions.

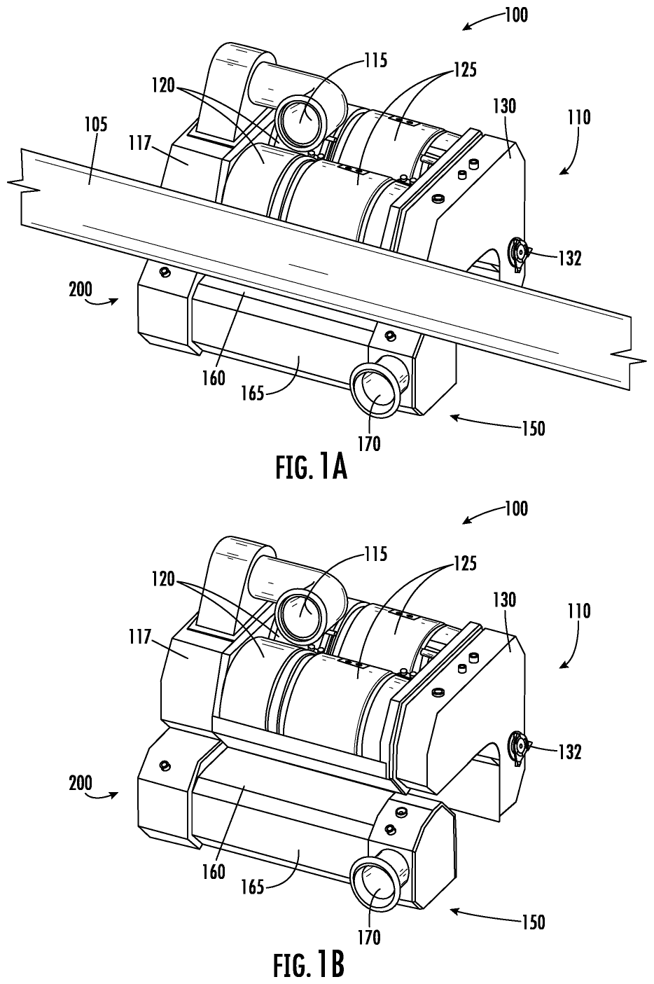

Referring to FIGS. 1A-3, an exhaust aftertreatment system or a one-box is shown as system 100, according to an embodiment. The system 100 is configured to receive the exhaust gas from a vehicle, such as a diesel vehicle, and treat the exhaust gas before releasing it to atmosphere. The system 100 can be mounted to a frame rail of the vehicle, shown as frame rail 105. The frame rail 105 can be a longitudinal frame rail of the vehicle. In some embodiments, a portion of the system 100 extends below the frame rail 105. The extending portion allows the system 100 to be installed closer to the centerline of the vehicle by moving some components to overlap with the frame rail 105.

The system 100 includes a first emission control module shown as first housing 110, a second emission control module shown as second housing 150, and a connecting cover shown as connecting portion 200. The connecting portion 200 couples the first housing 110 with the second housing 150. The first housing 110 may be coupled at least partially on top of the second housing 150. In some embodiments, the frame rail 105 is positioned adjacent the first housing 110 and above at least a portion of the second housing 150.

As shown in FIGS. 1A-4, the first housing 110 includes an exhaust gas inlet, shown as inlet 115. Inlet 115 is configured to fluidly couple with a supply of exhaust gas of from a vehicle. In some embodiments, inlet 115 is positioned facing in towards a centerline of the vehicle, shown in FIG. 1 as inlet 115 facing the frame rail 105. In some embodiments, the inlet 115 is made of a multi-segmented welded tube. In other embodiments, the inlet 115 is made of a single bent tube. The inlet 115 can be made of any material capable of withstanding the heat and corrosive properties of the exhaust gas, including metal (i.e., steel, stainless steel, aluminized steel, cast iron, or other metals), ceramic, or plastic.

The first housing 110 can include a one or more of treatment systems for the exhaust gas. As shown in FIGS. 1A and 1B, the first housing 110 includes one or more of DOCS shown as DOCs 120 fluidly coupled to the inlet 115. The DOCs 120 are a type of catalytic converter configured to reduce CO, HC, and PM in the exhaust gas. Generally, the DOCs include a high-surface area substrate coated in a catalyst (i.e., platinum metal catalysts). The hot exhaust gas passes over the substrate and one or more pollutants in the exhaust gas (i.e., CO, HCs, the soluble organic fraction of the PMs) are converted into carbon dioxide and water. In some embodiments, the first housing 110 includes two DOCs 120 arranged in parallel, though in other embodiments the first housing 110 includes more or fewer DOCs. As shown in the first portion 110, the DOCs 120 can be fluidly coupled to the inlet 115 via a DOC manifold shown as DOC manifold 117. The DOC manifold 117 divides the stream of exhaust gas from the inlet 115 into two substantially equally streams for the DOCs 120. In some embodiments, the DOC manifold 117 couples to the DOCs 120 by one or more multi-segmented welded cones, while in other embodiments the cone is a unitary spun cone.

The first housing 110 includes one or more DPFs, shown as DPFs 125. In some embodiments, the first housing 110 includes two DPFs 125 fluidly coupled to the two DOCs 120. In other embodiments, the first housing 110 includes more or fewer DPFs 125, for example the first housing 110 can include the same number of DPFs 125 as DOCs 120. In some embodiments, the DPFs 125 are arranged in parallel with the DOCs 120, such that the exhaust gas from one DOC 120 passes directly to a DPF 125 without substantially changing directions. Generally, DPFs include one or more filters designed to trap and hold PM from the exhaust gas as the exhaust gas passes through the DPF.

The first housing 110 includes a manifold fluidly coupled to the plurality of DPFs 125, shown as DPF manifold 130. In some embodiments, the DPF manifold 130 combines the exhaust gas stream from the DPFs 125. A mixing chamber or a decomposition chamber, shown as mixing chamber 135 is fluidly coupled to the DPF manifold 130 to receive the combined exhaust gas stream. The DPF manifold 130 directs the combined exhaust gas from the DPFs 125 to the mixing chamber 135, such that the combined exhaust gas stream is travels through the mixing chamber 135 in a second direction opposite the first direction of the exhaust gas through DOCs 120 and the DPFs 125. In some embodiments, the DPF manifold 130 is substantially L-shaped, with the DPFs 125 coupled one branch of the L-shaped first housing 110 and the mixing chamber 135 coupled to the other branch of the L-shaped first housing 110, allowing for the second housing 150 to be positioned at the joint between the two branches of the L-shaped first housing 110.

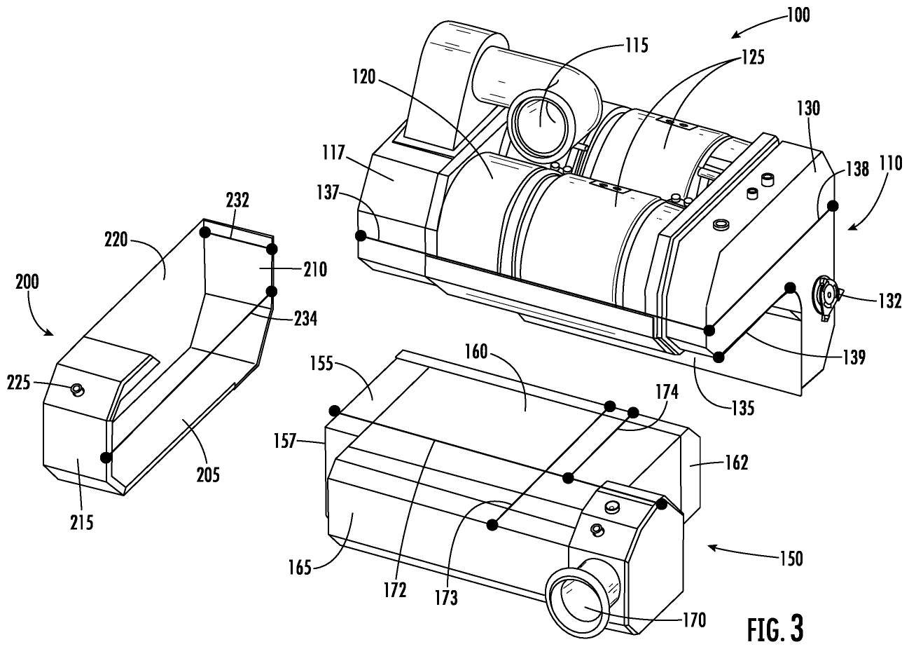

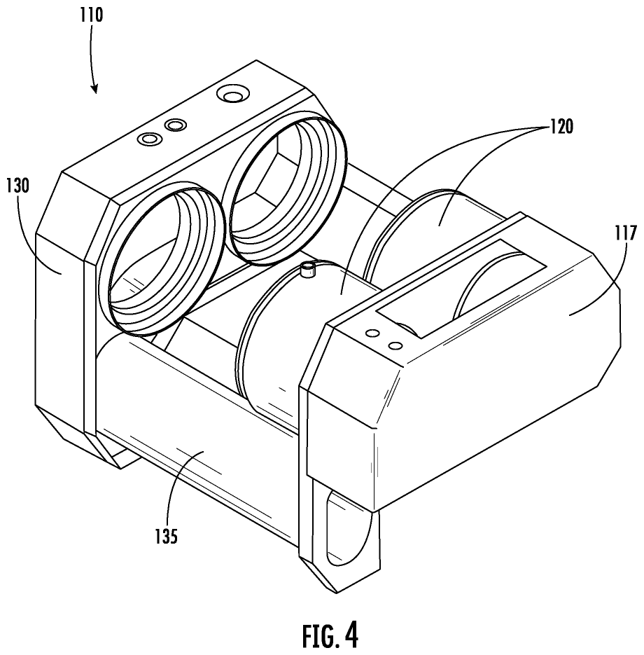

As shown in FIGS. 1A, 1B, and 3, in some embodiments the DPF manifold 130 includes a DEF injector shown as DEF injector 132. The DEF injector 132 can be fluidly coupled to a supply of DEF and inject the DEF into the exhaust gas stream. Generally, DEF fluid is an aqueous urea solution configured to chemically react with pollutants in the exhaust gas stream and convert them to nitrogen and water. In some embodiments, the DEF injector 132 atomizes the DEF to increase the surface area and speed of the chemical reactions. In some embodiments, the DEF injector 132 is positioned before the mixing chamber 135 and configured to inject the DEF into the exhaust gas stream prior to the exhaust gas stream entering the mixing chamber 135. In other embodiments, the DEF injector 132 is positioned to inject DEF directly into the mixing chamber 135. The mixing chamber 135 allows the DEF to mix with the exhaust.

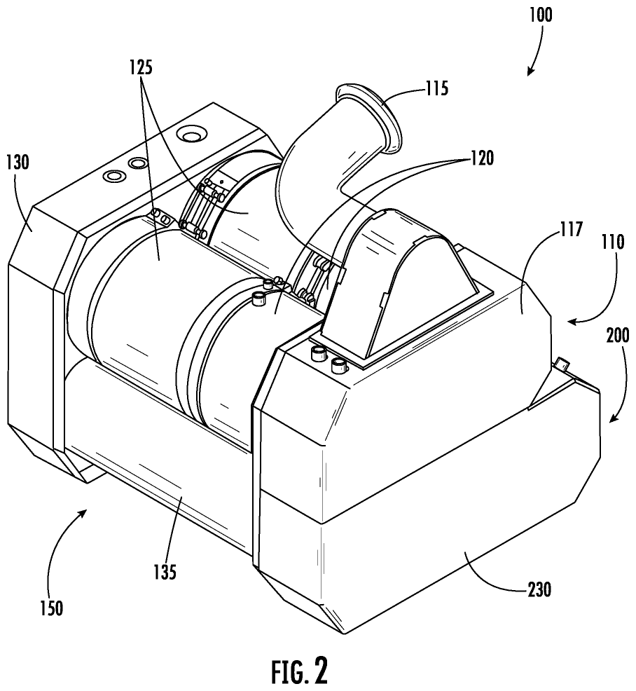

As shown in FIG. 2, the mixing chamber 135 receives the exhaust gas from the DPF manifold 130 and transfers it to the connecting portion 200. Referring now to FIG. 3, the connecting portion 200 includes bottom wall shown as bottom wall 205, a first end wall extending from an end of the bottom wall 205 shown as first end wall 210, a second end wall extending from another end of the bottom wall 205 shown as second end wall 215, and a side wall extending up from the bottom wall 205 and connecting the first end wall 210 and the second end wall 215 shown as side wall 220. In some embodiments, the connecting portion includes one or more sensors or access points for sensors to measure one or more aspects of the exhaust gas stream within the connecting portion. For example, as shown in FIG. 3, the connecting portion 200 includes a temperature sensor 225 to sense a temperature of the exhaust gas.

The connecting portion 200 is configured to couple with the first housing 110 and the second housing 150 to complete the flow path of the exhaust gas. In some embodiments, an outer channel 230 is formed by the coupling of the first housing 110, the second housing 150, and the connecting portion 200. A bottom of the DOC manifold 117 is positioned as a top of the outer channel 230 substantially opposite of the bottom wall 205, and an outer wall of the second housing 150 is positioned substantially opposite of the side wall 220 to form the outer channel 230. In said embodiments, the exhaust gas passes through the mixing chamber into the outer channel 230 of the connecting portion before passing into the second housing 150.

The second housing 150 includes an inner channel, shown as inner channel 155, to receive the exhaust gas from the outer channel 230. In some embodiments, the inner channel 155 is contained partially within the outer channel 230, such that the outer channel 230 wraps around the inner channel 155. In said embodiments, an outer wall of the inner channel 155 shown as outer wall 157 is shared between the inner channel 155 and the outer channel 230-serving as the wall opposite the side wall 220 for the outer channel 230 and as a wall of the inner channel 155.

The second housing 150 includes one or more treatment systems for treating the exhaust gas. As shown in FIG. 3, the second housing 150 includes one or more SCR/ASC systems, shown as SCR 160. Generally a SCR/ASC system includes one or more SCR modules to remove NOx from the exhaust gas stream and one or more ammonia slip catalysts (ASCs) to remove excess ammonia that may be present in the exhaust gas after the SCR. The SCR 160 receives the exhaust gas from the inner channel 155 and provides the exhaust gas to an outlet, shown as outlet 170. In some embodiments, the SCR 160 includes an SCR inlet shown as SCR inlet 162 positioned between the inner channel 155 and the SCR 160. The SCR inlet 162 may distribute the exhaust gas across the SCR 160. In some embodiments, the SCR 160 includes an SCR outlet shown as SCR outlet 165. The SCR outlet 165 may collect the exhaust gas from the SCR 160 and provide it to the outlet 170.

Referring specifically to FIG. 3, the first housing 110 has a length shown as a first housing length 137 and a width shown as a first housing width 138. The second housing 150 has a length shown as second housing length 172 and a width shown as second housing width 173. The connecting portion 200 has a length shown as connecting portion length 232 and a width shown as connecting portion width 234. In some embodiments, a portion of the first housing width 138 shown as the first portion 139 and a portion of the second housing width 173 shown as the second portion 174 are overlapping. The overlapping portions can be less than the widths of the first housing width 138 and the second housing width 173 such that a portion of the second housing 150 is not overlapped by the first housing 110. As shown in FIG. 1, the portion of the second housing 150 not overlapped by the first housing 110 can be positioned beneath the frame rail 105 to minimize the size of the system 100 once installed on a vehicle. Similarly, a portion of the length of the connecting portion 200 can be positioned beneath the frame rail 105. In some embodiments, the first housing length 137 is greater than the second housing length 172. In some embodiments, the first housing length 137 is equal or substantially equal to the second housing length 172 plus the connecting portion length 232. The complete system 100 may have a total length the same or substantially equal to the first housing length 137, and a width the same or substantially equal to the connecting portion width 234.

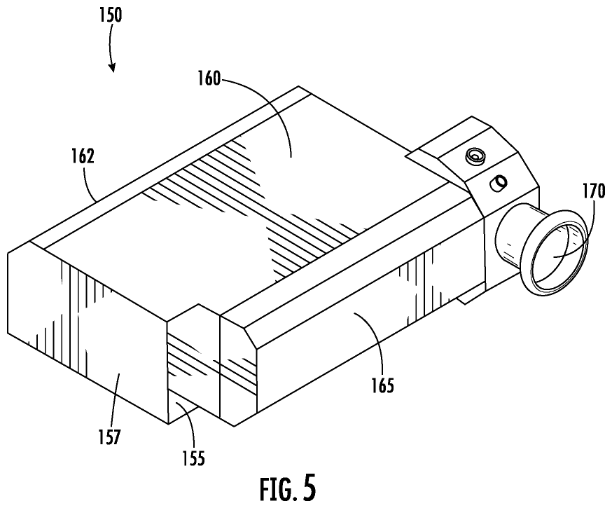

Referring to FIG. 4, the first housing 110 is shown with the DPFs 125 removed to illustrate that the DPF manifold 130 is substantially hollow and directs the exhaust gas stream from the DOCs 120 and the DPFs 125 down and then into the mixing chamber 135 in a second direction that is substantially parallel to and opposite of the first direction through the DOCs 120 and the DPFs 125.

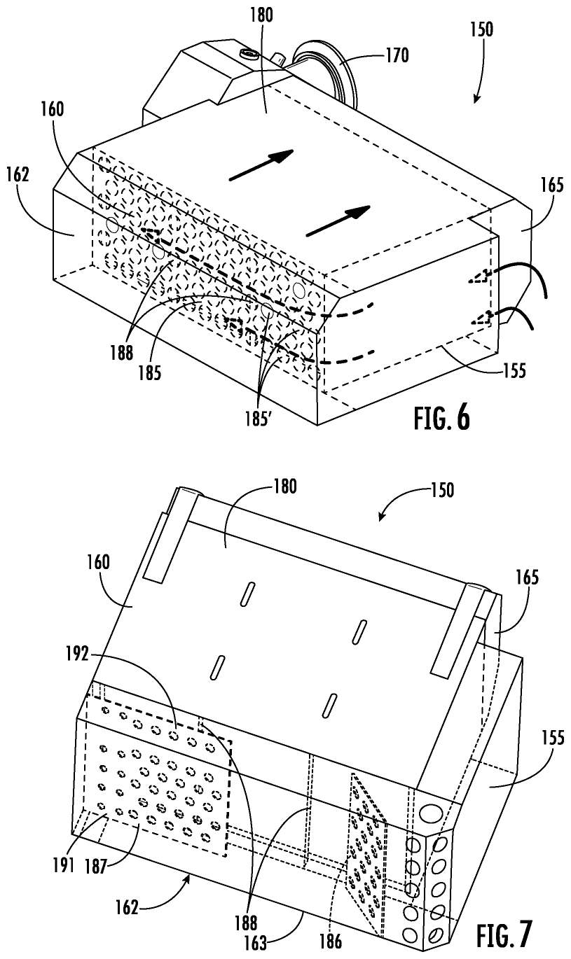

As shown in FIGS. 5 and 6, the second housing 150 can include a shell 180 at least partially surrounding the SCR 160 including one or more SCR elements 163. In some embodiments, the shell 180 includes insulation configured to thermally insulate the SCR 160 from the other components of the system 100 and/or the external environment. The second housing 150 may include one or more braces, shown as braces 188. The braces 188 provide support for the SCR 160, to reduce the risk of the SCR 160 foil telescoping with aging and vibration, and the braces 188 may also serve as a stop for position the SCR elements 163 against. The second housing 150 may also include one or more perforated plates shown as perforated plate 185 at the start of the one or more SCR elements in the SCR 160. The one or more perforated plates 185 can act as flow distributers to encourage uniform flow of exhaust gas across the SCR elements in the SCR 160. The one or more perforated plates 185 include a plurality of perforations (i.e., apertures) to allow the exhaust gas to pass through the SCR 160 to distribute the exhaust gas more evenly across the SCR 160, shown as apertures 185′. In some embodiments, the apertures 185′ are in an ordered arrangement (i.e., rows, columns, etc.) while in other embodiments the apertures 185′ may be random. In some embodiments, the apertures 185′ are of one or more shapes (i.e., circles, squares, rectangles, or any other shape).

In some embodiments, the one or more perforated plates 185 is a single plate. In other embodiments, the one or more perforated plates 185 are composed of multiple plates. For example, referring to FIG. 7, the SCR 160 can include a first perforated plate 186 and a second perforated plate 187. The first perforated plate 186 is positioned near the transition from the inner channel 155 to the SCR inlet 162. The first perforated plate 186 can be arranged at an angle compared to the direction of flow of the exhaust gas in the SCR inlet 162. The angle of the first perforated plate can be adjusted to affect the distribution of flow between the back wall 161 and the face of the SCR elements 163 in the SCR 160, in a direction perpendicular to the length of the SCR inlet 162. In some embodiments, the first perforated plate 186 can be positioned at angle at or between 90 degrees (i.e., perpendicular to the flow of the exhaust gas) and 180 degrees (i.e., substantially parallel with the flow of the exhaust gas) as measured from a back wall 161 of the SCR inlet 162 from the first perforated plate 186 towards the second perforated plate 187. For example, the first perforated plate 186 can be positioned at an angle substantially equal to 135 degrees. The angle can be adjusted based on the velocity of the exhaust gas, the number/size/arrangement of the apertures, or the exposed surface area of the SCR 160. The second perforated plate 187 can be arranged at a terminal end of the SCR inlet 162. In some embodiments, the second perforated plate 187 acts to distribute the flow of the exhaust gas as the exhaust gas is redirected by the end of the SCR inlet 162. In some embodiments, the second perforated plate 187 is arranged substantially parallel with the back wall 161. In other embodiments, the second perforated plate 187 can be arranged at an angle in the same manner as the first perforated plate 186.

In some embodiments, the apertures 185′ may be arranged into one or more discrete groups to aid in the uniform distribution of exhaust gas across the SCR elements 163. Referring still to FIG. 7, in the second perforated plate 187, there can be a first group of apertures 191 comprising the first two columns of apertures 185′ from the left-side of the second perforated plate 187, and a second group of apertures 192 comprised of the five remaining offset columns of apertures 185′. In some embodiments, the first group of apertures 191 have a smaller diameter and/or a smaller total group surface area than the second group of apertures 192. For example, the change in direction of the exhaust gas caused by the termination of the SCR inlet 162 can cause an increase in pressure proximate the first group of apertures 191 relative to the pressure along the rest of the SCR inlet 162. The reduced diameter of the first group of apertures 191 can compensate for the increased pressure to ensure a uniform distribution of exhaust gas across the SCR 160. While only two discrete groups of apertures 185′ are shown, it should be understood that there can be any number of different groups of apertures. In some embodiments, the first perforated plate 186 can also have a plurality of unique, discrete apertures 185′ with different sizes, shapes, or other properties.

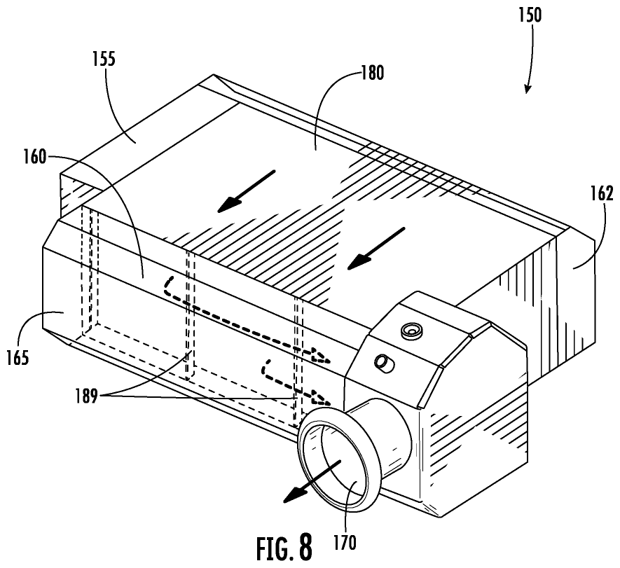

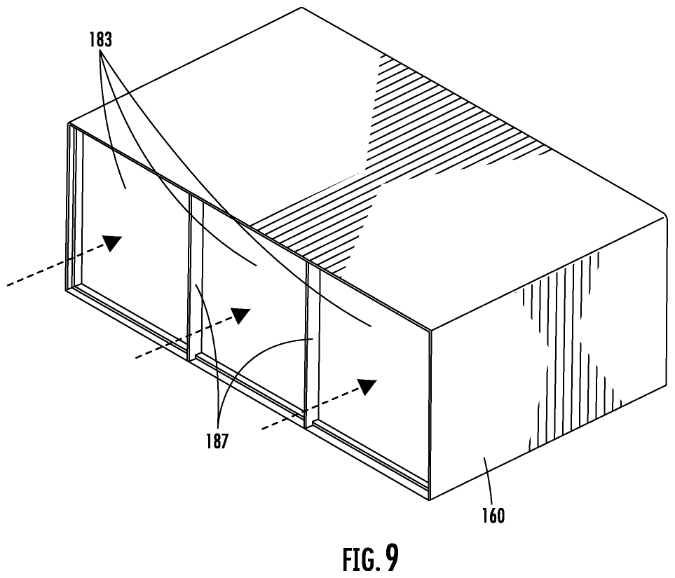

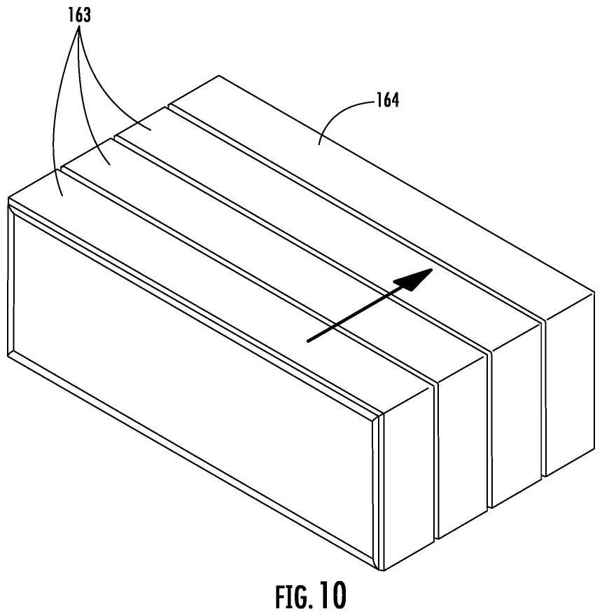

As shown in FIG. 8, the second housing 150 may also include one or more braces, shown as braces 189, for retaining the SCR and ASC elements in the SCR 160. The SCR system 160 can contain one or more SCR elements, shown as SCR elements 163 in FIGS. 9 and 10. The SCR elements 163 are rectangular and configured to substantially fill the cross-section of the SCR 160. While shown as rectangular elements, the shape of the SCR elements 163 can be any shape to fill or substantially fill the SCR 160. In some embodiments, the SCR 160 contains three SCR elements, though in other embodiments the SCR 160 can contain fewer or more SCR elements 163. The SCR 160 also contains one or more ASC elements, shown as ASC element 164. In some embodiments, the SCR 160 contains a single ASC element 164, though in other embodiments the SCR 160 can contain fewer or more ASC elements 164. In some embodiments, the SCR elements 163 and the ASC element 164 can have the same or substantially the same dimensions and shape. For example, the SCR elements at or substantially near a length of 22 inches, a height of 8 inches, and a thickness of 3.15 inches.

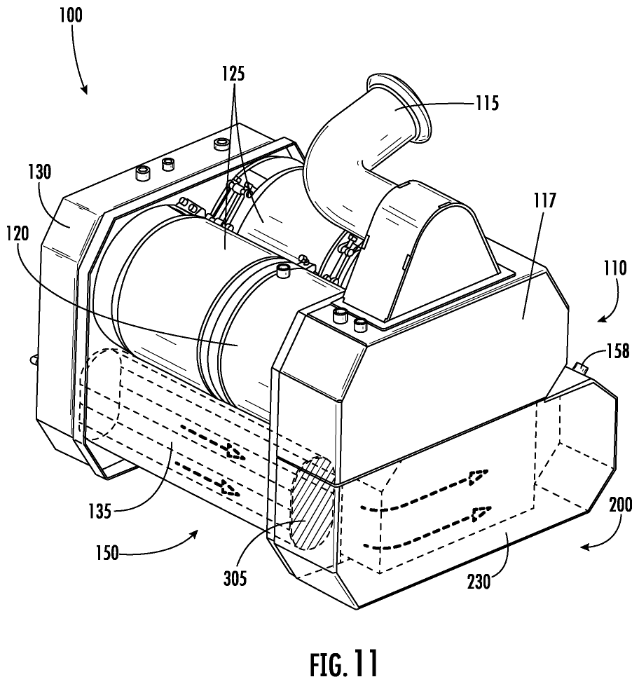

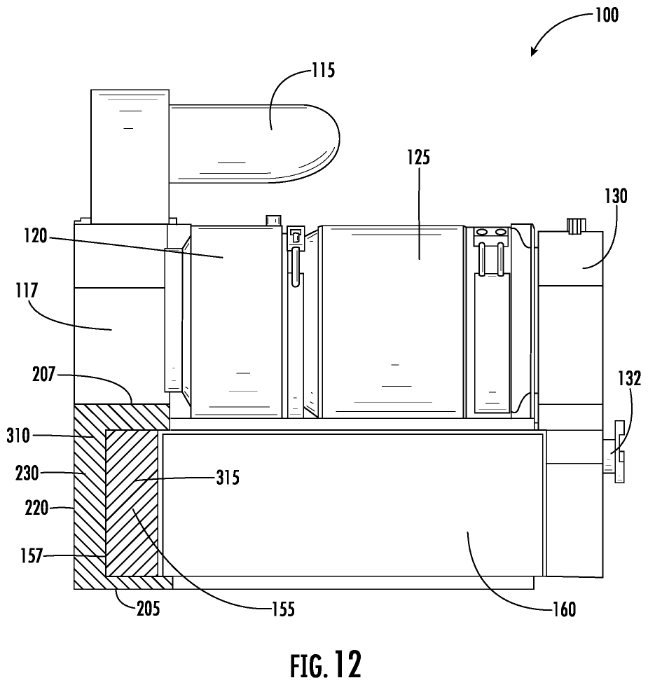

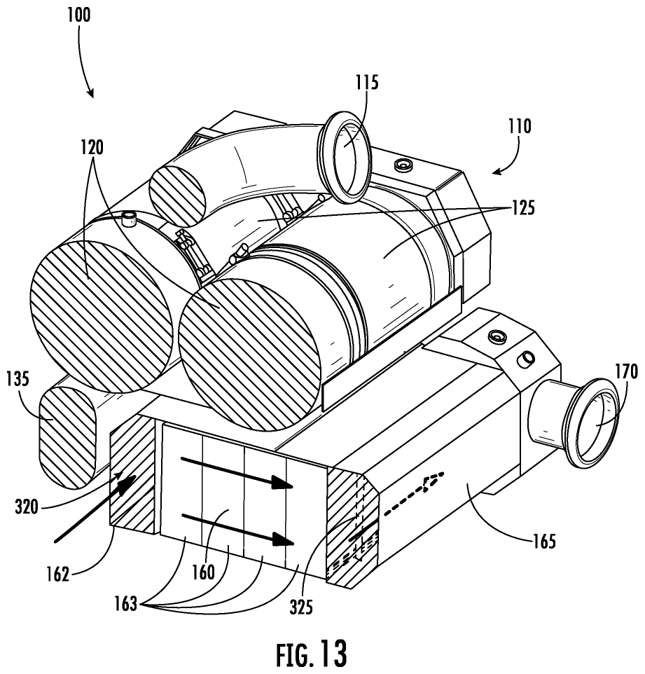

Referring now to FIGS. 11-13, the one or more flow channels in system 100 may include equal or substantially equal cross-sections along the flow path of the exhaust gas. By maintaining an equal or substantially equal (i.e., +/−15%) cross-section across one or more portions of the exhaust gas flow path, excessive pressure drops caused by the rapid change of flow velocity due to changes in the flow path cross-section are reduced. For example, the cross-section along the one or more flow channels of the system 100 can equal or substantially equal 25 inches squared. As shown in FIG. 11, a cross-section of the mixing chamber 135 shown as the first cross-section 305 can equal or substantially equal 24.69 inches squared. As shown in FIG. 12, a cross-section of the outer channel 230 shown as a second cross-section 310 can equal or substantially equal 27.66 inches squared. The outer channel 230 is formed by the bottom wall 205 and the side wall 220 of the connecting portion 200, a bottom of the DOC manifold 117 positioned as a top of the outer channel 230 shown as top wall 207, and the outer wall 157 of the second housing 150. Still referring to FIG. 12, the cross-section of the inner channel 155 of the second housing 150 shown as the third cross-section 315 can equal or substantially equal 24.32 inches squared. As shown in FIG. 13, the cross-sectional area of the SCR inlet 162 shown as the fourth cross-section 320 can equal or substantially equal 24.66 inches squared, and the cross-sectional area of the SCR outlet 165 shown as the fifth cross-section 325 can be equal or substantially equal to 22.62 inches squared. In some embodiments, the first, second, third, fourth and fifth cross sections 305, 310, 315, 320, and 325 may be equal or substantially equal in area while other segments or portions of the exhaust gas flow path are not equal or substantially equal to the first, second, third, fourth and fifth cross sections 305, 310, 315, 320, and 325. For example, first, second, third, fourth and fifth cross sections 305, 310, 315, 320, and 325 may be substantially equal to 25 inches squared, whereas the area of the SCR elements 163 may be equal or substantially equal to 176 inches squared. Still in other embodiments, the entire exhaust gas flow path may be substantially equal in cross-sectional area.

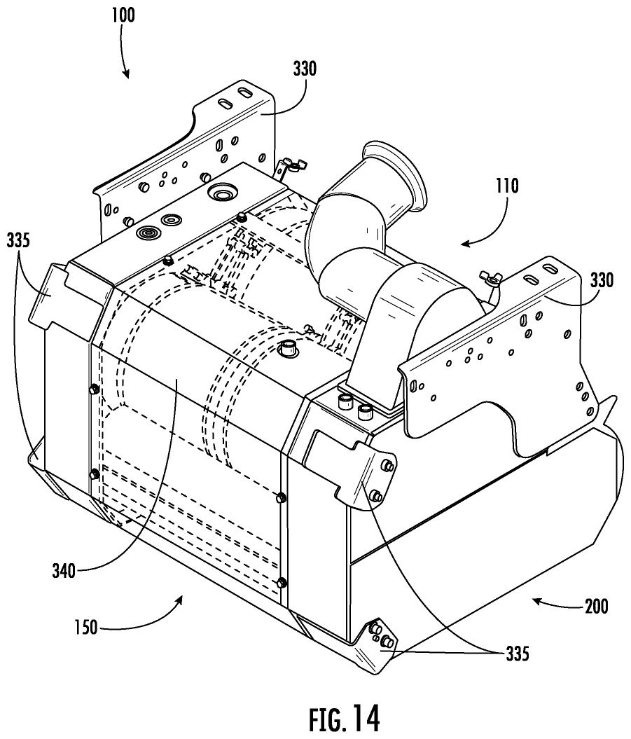

As shown in FIG. 14, the system 100 can include one or more mounts shown as mounts 330 for coupling the system 100 to the one or more frame rails 105 of the vehicle, In some embodiments, the mounts 330 are directly coupled to the first housing 110 and indirectly coupled to the second housing 150. In other embodiments, the mounts 330 are directly coupled to one or more of the first housing 110, the second housing 150, or the connecting portion 200. The system 100 may include one or more mounts 335 to provide support or additional mounting mounts to the system 100. The mounts 330 and mounts 335 may be coupled (e.g., bolted, welded, screwed, glued, or some other method of fastening) to the exteriors of the first housing 110, the second housing 150, or the connecting portion 200. In some embodiments, the mounts 330 or the mounts 335 are used to mount one or more sensors to the system 100. The system 100 may also include one or more heat shields, shown as heat shields 340, at least partially surrounding a portion of the system 100. For example, the heatshield 340 may cover the DOCs 120 and the DPFs 125 of the first housing 110 to prevent or substantially prevent interaction between a user of the vehicle and the DOCs 120 and DPFs 125. In some embodiments, the heat shield 340 may extend over one or more of the first housing 110, the second housing 150, or the connecting portion 200.

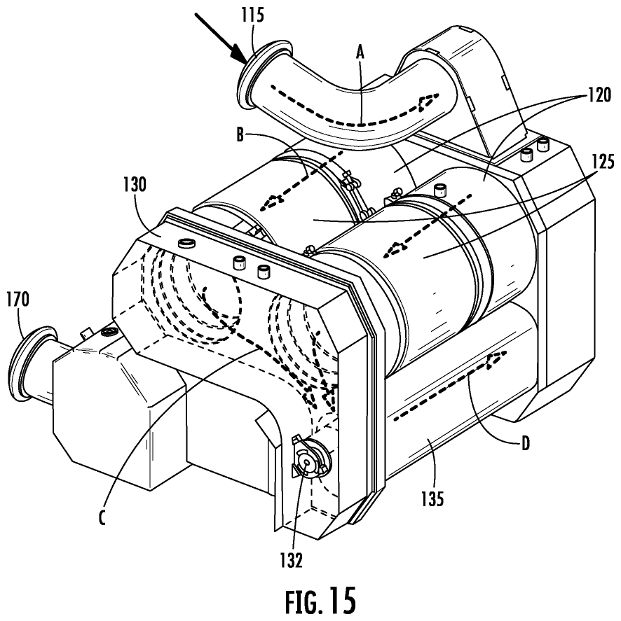

Referring now to FIGS. 15-18, an example flow path of the exhaust gas through the system 100 is shown, according to an embodiment. As used herein, the term length is used to denote the dimension in parallel with the flow of gas through the DOCs 120, the DPFs 125, and the mixing chamber 135, wherein the term width is used to denote the dimension in parallel with the flow of the gas through the SCR 160. Further, terms of degree relating to height are in reference to the top of the system 100 proximate the inlet 115 and the bottom of the system 100 proximate the exterior face of the SCR 160.

As shown in FIG. 15, the exhaust gas enters the system 100 at the inlet 115 and follows the flow path A into the DOC manifold 117, at which point the exhaust gas is split into two streams which flow along the flow path B from a left side of the system 100 to a right side of the system 100 through the DOCs 120 and the DPFs 125. At the DPF manifold 130, the two separate exhaust gas streams are recombined and directed down along the flow path C towards the DEF injector and the beginning of the mixing chamber 135. Passing into the mixing chamber 135, the exhaust gas follows the flow path D in a direction substantially opposite to and substantially parallel with the direction of the exhaust gas along flow path B. In some embodiments, the flow path D is at or below the flow path B. In some embodiments, the flow path D overlaps only partially with the flow paths B through the DOCs 120 and the DPFs 125.

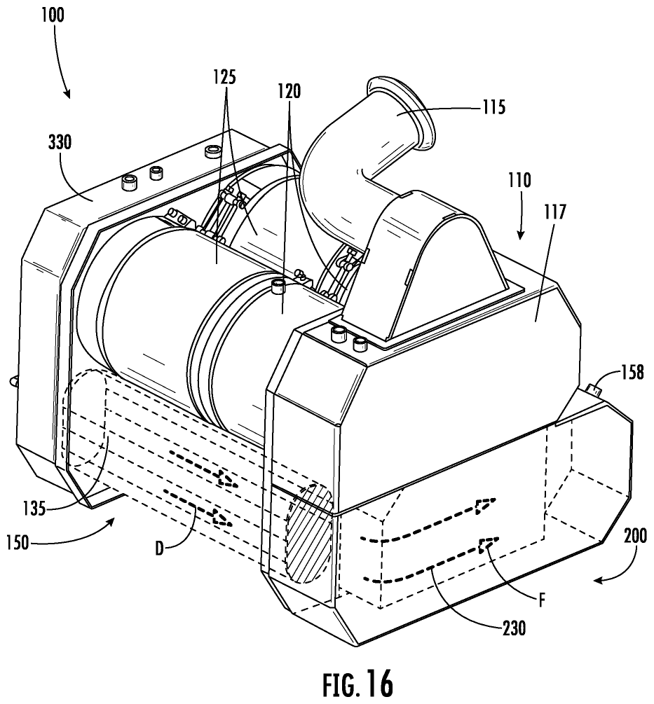

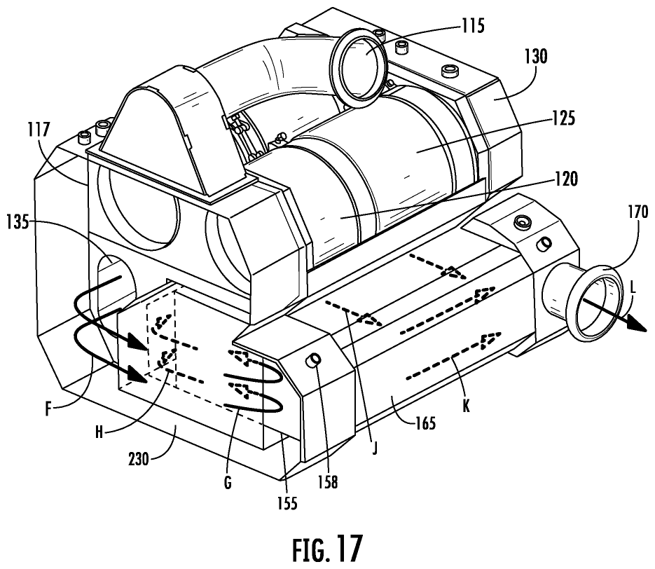

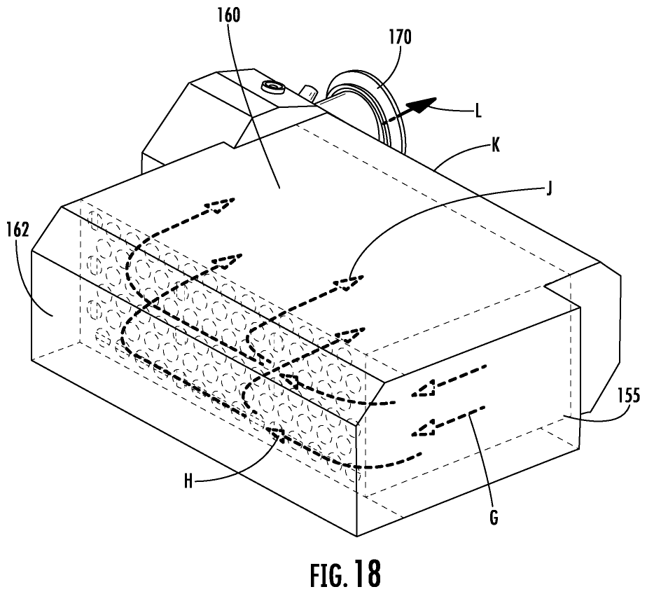

As shown in FIG. 16, the exhaust gas traveling along the flow path D passes from the mixing chamber 135 into the outer channel 230 along the flow path F. The flow path F is substantially perpendicular to the flow path B and the flow D. As shown in FIG. 17, the exhaust gas passes from the outer channel 230 to the inner channel 155 along the flow path F to flow path G. In passing from the outer channel 230 to the inner channel 155 the exhaust gas is forced to pass proximate to the temperature sensor aperture 158. The temperature sensor aperture 158 can receive a temperature sensor to monitor the temperature of the exhaust gas along flow path F to flow path G. The outer wall 157 of the of the second housing 150 directs the exhaust gas past the temperature sensor aperture 158. The direction of the gas along the flow path G is substantially opposite to and substantially parallel with the direction of flow along the flow path F. The exhaust stream then passes into the SCR inlet 162 from the flow path G along the flow path H. As shown in FIG. 18, the flow path H is in a direction substantially parallel to the flow path D, and substantially parallel but opposite to the direction of flow in flow path B. The exhaust gas then passes from the SCR inlet 162 into the SCR 160 along the flow path J. The flow path J is substantially perpendicular to the flow path B, the flow path D, and the flow path H. In some embodiments, the flow path J passes at least partially under a portion of the flow path B. When mounted on the frame rail 105 of a vehicle, the flow path J may be perpendicular with the longitudinal rails of the vehicle. After passing through the SCR 160, as shown in FIGS. 17 and 18, the gas travels through the SCR outlet 165 along the flow path K in a direction substantially perpendicular with the flow path J. The flow path K may be substantially parallel with and substantially opposite the flow path D. The exhaust gas then exits the system 100 through the outlet 170 in a direction along the flow path L. The flow path L may be substantially parallel with and opposite to the direction of the flow of exhaust gas into the system 100 at the inlet 115.

As utilized herein with respect to numerical ranges, the terms “approximately,” “about,” “substantially,” and similar terms generally mean+/−15% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. An exhaust aftertreatment system for a vehicle comprising first and second longitudinal frame rails, the exhaust aftertreatment system comprising:
a first housing comprising:
a first inlet configured to be fluidly coupled to a supply of an exhaust gas;
a plurality of diesel oxidation catalysts fluidly coupled to the first inlet;
a plurality of diesel particulate filters fluidly coupled to the plurality of diesel oxidation catalysts; and
a mixing chamber fluidly coupled to the plurality of diesel particulate filters; and
a second housing comprising:
an inner channel fluidly coupled to the mixing chamber of the first housing;
a selective catalytic reduction catalyst fluidly coupled to the inner channel; and
an outlet fluidly coupled to the selective catalytic reduction catalyst and configured to permit the exhaust gas to exit the system,
wherein the first housing is fluidly coupled to the second housing by a connecting portion.

2. The exhaust aftertreatment system of claim 1, wherein the first housing has a first housing width and the second housing has a second housing width, wherein at least a portion of the second housing width does not overlap with the first housing width, and wherein one of the first and second longitudinal frame rails is positioned adjacent the first housing and at least partially above the portion of the second housing width that does not overlap with the first housing width.

3. The exhaust aftertreatment system of claim 1, wherein the first housing, the second housing, and the connecting portion comprise a one-box assembly, the one-box assembly having a one-box assembly length and a one-box assembly width, wherein the plurality of diesel oxidation catalysts, the plurality of diesel particulate filters and the mixing chamber extend in a lengthwise direction along the one-box assembly length, and wherein the selective catalytic reduction catalyst extends in a widthwise direction along the one-box assembly width.

4. The exhaust aftertreatment system of claim 1, further comprising an outer channel fluidly coupling the mixing chamber to the inner channel, wherein the outer channel is formed in part by the connecting portion and the second housing.

5. The exhaust aftertreatment system of claim 4, wherein the outer channel and the inner channel share a channel wall.

6. The exhaust aftertreatment system of claim 1, the selective catalytic reduction catalyst comprising a plurality of selective catalytic reduction converters and at least one ammonia slip catalyst system.

7. The exhaust aftertreatment system of claim 1, further comprising one or more flow distributors upstream of the selective catalytic reduction catalyst.

8. The exhaust aftertreatment system of claim 1, wherein the plurality of diesel oxidation catalysts and the plurality of diesel particulate filters are arranged perpendicular to the selective catalytic reduction catalyst.

9. The exhaust aftertreatment system of claim 1, wherein the selective catalytic reduction catalyst at least partially overlaps with just one of at least one of the plurality of diesel oxidation catalysts or the plurality of diesel particulate filters.

10. The exhaust aftertreatment system of claim 1, further comprising:
a selective catalytic reduction catalyst inlet;
a selective catalytic reduction catalyst outlet; and
an outer channel fluidly coupling the mixing chamber to the inner channel,
wherein flow path cross-sections of each of the mixing chamber, the outer channel, the inner channel, the selective catalytic reduction catalyst inlet, and the selective catalytic reduction catalyst outlet are substantially equal.

11. An exhaust aftertreatment system for a vehicle with first and second longitudinal frame rails, the exhaust aftertreatment system comprising:
an inlet configured to be fluidly coupled to a supply of an exhaust gas;
a plurality of diesel oxidation catalysts fluidly coupled to the inlet;
a plurality of diesel particulate filters fluidly coupled to the plurality of diesel oxidation catalysts;
a mixing chamber fluidly coupled to the plurality of diesel particulate filters;
a selective catalytic reduction catalyst fluidly coupled to the mixing chamber; and
an outlet fluidly coupled to the selective catalytic reduction catalyst and configured to permit the exhaust gas to exit the system,
wherein the exhaust gas passes through the plurality of diesel oxidation catalysts and the plurality of diesel particulate filters in a first direction, through the mixing chamber in a second direction substantially opposite to the first direction, and through the selective catalytic reduction catalyst in a third direction substantially perpendicular to the first direction and the second direction.

12. The exhaust aftertreatment system of claim 11, further comprising:
a first housing comprises the inlet, the plurality of diesel particulate filters, and the mixing chamber;
a second housing comprising the selective catalytic reduction catalyst and the outlet; and
a connecting portion coupling the first housing with the second housing.

13. The exhaust aftertreatment system of claim 11, wherein the mixing chamber is fluidly coupled to the selective catalytic reduction catalyst by an outer channel formed at least in part by the connecting portion and the second housing.

14. The exhaust aftertreatment system of claim 13, the second housing further comprising an inner channel, wherein the inner channel fluidly couples the outer channel to the selective catalytic reduction catalyst.

15. The exhaust aftertreatment system of claim 11, wherein the plurality of diesel particulate filters are arranged perpendicular to the selective catalytic reduction catalyst.

16. The exhaust aftertreatment system of claim 11, wherein the selective catalytic reduction catalyst is at least partially beneath just one of the plurality of diesel particulate filters.

17. The exhaust aftertreatment system of claim 11, the selective catalytic reduction catalyst comprising a plurality of selective catalytic reduction converters and at least one ammonia slip catalyst system.

18. The exhaust aftertreatment system of claim 11, wherein at least a portion of the selective catalytic reduction catalyst does not overlap with the plurality of diesel particulate filters, and wherein one of the first and second longitudinal frame rails is positioned adjacent the plurality of diesel particulate filters and at least partially above the portion of the selective catalytic reduction catalyst.

19. The exhaust aftertreatment system of claim 11, further comprising a diesel exhaust fluid injector positioned proximate a mixing chamber inlet of the mixing chamber.

20. The exhaust aftertreatment system of claim 11, further comprising:
a selective catalytic reduction catalyst inlet;
a selective catalytic reduction catalyst outlet;
an outer channel fluidly coupled to the mixing chamber; and
an inner channel fluidly coupled to the outer channel and the selective catalytic reduction catalyst,
wherein flow path cross-sections of each of the mixing chamber, the outer channel, the inner channel, the selective catalytic reduction catalyst inlet, and the selective catalytic reduction catalyst outlet are substantially equal.
